(19) United States
(12) Patent Application Publication
(10) Pub. No.: US 2007/0134493 A1
(43) Pub. Date: Jun. 14, 2007

(54) Compositions and capsules with stable hydrophilic layers

(76) Inventor: Kanji Meghpara, Morris Plains, NJ (US)

Correspondence Address: Barry H. Jacobsen;Attorney for Applicant, Warner-Lambert Company LLC, 201 Tabor Road, Morris Plains, NJ, 07950, US

(21) Appl. No.: 11/296,989

(22) Filed: Dec. 8, 2005

(51) Int. Cl. B32B 9/00

(52) U.S. Cl. 428/402.2

(57) ABSTRACT

Several embodiments of the present invention provide a capsule including a hydrophobic inner core layer and at least one hydrophilic outer layer. The outer layer may be seamless and may include at least one hygroscopic polyol and at least one polyol with a low hygroscopicity. The at least one outer layer may include at least one film or gel forming agent. Such capsules are stable and experience minimal or no degradation under accelerated stability conditions.

### FIELD OF THE INVENTION

The present invention relates to capsules including at least one hydrophobic inner core layer and at least one hydrophilic outer layer. Such capsules experience minimal or no degradation under accelerated stability conditions.

### DESCRIPTION OF RELATED ART

Oral dosage forms may be designed to disintegrate in the buccal cavity. Such dosage forms desirably disintegrate in the buccal cavity of a consumer with pleasing attributes or the dosage form will not be acceptable. Desirably, disintegrating dosage forms will disintegrate in the mouth in a rapid manner, provide a pleasing taste and not leave a residue behind.

Capsules may be manufactured to disintegrate in the buccal cavity. Typically, a film forming or gelling agent is used in an outer layer of a capsule. Gelatin is one such gelling agent; however, gelatin alone does not provide desirable attributes for a fast disintegrating dosage form because the gelatin may not rapidly disintegrate in the buccal cavity and consequently may leave a residue in the mouth for an unacceptable period of time. Additives may be added to enhance the disintegration of an outer layer that contains gelatin. However, these additives may cause unacceptable degradation to an outer capsule layer as evidenced in stressed conditions such as those required by stability testing for a product containing an active pharmaceutical agent.

Accordingly, it is desirable to provide a capsule designed to rapidly disintegrate in the buccal or oral cavity with pleasing attributes to a consumer and is stable even under stressed stability type conditions.

### SUMMARY

In several embodiments of the present invention there are provided capsules including at least one hydrophobic inner core and at least one hydrophilic outer layer; where the at least one outer layer includes at least one hygroscopic polyol and at least one polyol with a low hygroscopicity. In several embodiments of the present invention there are provided capsules including a hydrophobic inner core, a middle hydrophilic layer and at least one hydrophilic outer layer; where the outer layer includes at least one hygroscopic polyol and at least one polyol with a low hygroscopicity. In several embodiments of the present invention there are provided capsules including a hydrophobic inner core, a hydrophilic outer layer; where the outer layer includes at least one hygroscopic polyol and at least one polyol with a low hygroscopicity. A capsule may have a seamless outer layer, also known as a seamless capsule. In other embodiments, the at least one outer layer may include at least one film or gel forming agent, at least one hygroscopic polyol and at least one polyol with a low hygroscopicity. An outer layer may include gelatin, glycerin and isomalt. In various embodiments of the present invention, the outer appearance of the capsule is stable and experiences minimal or no degradation in stressed conditions such as those in accelerated stability conditions where the temperature and/or relative humidity is increased. Such stability conditions include 30° C./65% relative humidity or 45° C./75% relative humidity.

In other embodiments, there are provided capsules that include a hydrophobic inner core and a hydrophilic outer layer. A hydrophobic layer may include an active pharmaceutical ingredient (API) in a pharmaceutically effective amount. An active pharmaceutical ingredient may be encapsulated or partially encapsulated or adsorbed onto a complex. Such capsules are stable and experience minimal or no leaking, cracking or breaking in an outer layer. Another embodiment of the present invention provides a seamless capsule including phenylephrine in a therapeutically effective amount, wherein the phenylephrine is encapsulated or partially encapsulated or adsorbed onto a complex.

In further embodiments, there is provided a package which includes a capsule including a hydrophobic inner core and at least one hydrophilic outer layer, where the package may have drug facts attached thereto. An outer layer may include at least one hygroscopic polyol and at least one polyol with a low hygroscopicity. An outer layer may further include at least one film or gel forming agent.

Another embodiment of the present invention provides for a method of stabilizing a seamless capsule having a hydrophilic API in a hydrophobic inner layer and an outer shell that includes at least one film or gel forming agent, at least one hygroscopic polyol and at least one polyol with a low hygroscopicity. In one embodiment, there is provided a method of preventing or minimizing migration of a hydrophilic active pharmaceutical ingredient from a hydrophobic inner layer of a seamless capsule to an outer hydrophilic layer of said capsule by providing an active pharmaceutical ingredient in a therapeutically effective amount that is in a core hydrophobic layer and providing an outer hydrophilic layer that includes at least one film or gel forming agent, at least one hygroscopic polyol and at least one polyol with a low hygroscopicity. An active pharmaceutical ingredient may be encapsulated, partially encapsulated or adsorbed.

### BRIEF DESCRIPTION OF DRAWINGS

FIG. 1 is a cross section illustrating a capsule having an inner core layer and an outer shell layer as provided by one embodiment of the present invention.

FIG. 2 is a cross section illustrating a capsule having an inner core layer and an outer coating layer and an outer film layer as provided by one embodiment of the present invention.

FIG. 3 is a schematic cross section illustrating one embodiment of the present invention of the nozzle part of an apparatus which is suitable for producing seamless capsules.

### DETAILED DESCRIPTION

Various embodiments of the present invention provide for at least one outer layer that is considered to be hydrophilic also known as water soluble layer. In various embodiments the at least one outer layer of a capsule may include at least one hygroscopic polyol and at least one polyol with a low hygroscopicity. The at least one outer layer may include at least one film forming agent, at least one gel forming agent or a combination thereof.

Useful gel or film forming agents include, but is not limited to, gelatin. Gelatin may be used in the at least one outer layer which may also be the outer hydrophilic layer. Gelatin often takes some time to disintegrate in the oral cavity and may leave an undesirable residue in the oral cavity. Sugar alcohols also known as polyols may be added to the outer layer to help improve disintegration speed and mouth feel of a capsule. Useful sugar alcohols, also known as polyols, include hygroscopic polyols and include but are not limited to glycerin, sorbitol, mannitol, xylitol, maltitol, lactitol, erythritol and the like and combinations thereof. A useful polyol includes glycerin also known as glycerol. Polyols may be highly hydroscopic. If hygroscopic polyols are used in a hydrophilic outer layer of a capsule, then the outer layer may absorb large amounts of moisture. Consequently, the capsule may degrade and lose its integrity and may leak or become gooey or appear to melt. Such degradation can be seen under stressed conditions such as accelerated stability conditions. To minimize the degradation of a hydrophilic layer of a capsule, it has been found that adding at least one non-hygroscopic polyol or a polyol with low hygroscopicity to the hydrophilic layer increases the stability of an outer hydrophilic layer while maintaining the desirable ‘mouth feel’ for a orally disintegrating dosage form. During accelerated stability studies such as at 30° C./65% relative humidity, hydrophilic outer layers of a capsule experience minimal or no degradation. By adding a hygroscopic polyol such as glycerin and polyol with a low hygroscopicity such as isomalt to a hydrophilic outer layer, the outer layer is stable. Capsules with an outer layer that includes a polyol that has a low hygroscopicity maintains its integrity, e.g. the capsule does not leak, become gooey or appear to melt. Additionally, a capsule with an outer layer including a hygroscopic polyol and a polyol with a low hygroscopicity has a feel in the oral cavity is highly pleasing and disintegrates quickly without leaving undesirable residues.

A hygroscopic polyol refers to a polyol that absorbs water readily from its surroundings. A non-hydgroscopic polyol refers to a polyol that does not readily absorb water from its surroundings. A polyol with a low hygroscopicity absorbs minimal water from its surroundings.

Useful non-hygroscopic polyols or polyols with low hygroscopicity include but are not limited to isomalts. Such isomalts include those sold under the tradename PALATINIT produced by Palatinit, Germany. Palatinit Isomalt is an equimolar composition of 6-0-alpha-D-glucopyranosido-D-sorbitol (1,6-GPS) and 1-0-alpha-D-glucopyranosido-D-mannitol-dihydrate (1,1-GPM-dihydrate). Isomalt has advantageous properties. Isomalt has a low hygroscopicity and absorbs virtually no moisture at a temperature of 25° C. and relative humidities up to 85%. Isomalt's hygroscopicity is lower than that of almost all of the other polyols and even sugar itself. Without wishing to bound by any particular theory, it is believed that isomalt helps provide for the high stability of the capsules. This may be noticed particularly at accelerated stability conditions especially those at high temperatures and high relative humidity.

Capsules may be formulated to disintegrate and/or dissolve directly in the buccal cavity or in the GI tract or stomach area. In various embodiments, one useful capsule includes a fast disintegrating capsule that disintegrates in the buccal cavity. In several embodiments, the capsule is a standalone product that is capable of disintegrating completely in an oral cavity of a consumer. Standalone indicates that the capsule is meant to be directly consumed by a consumer and it is not incorporated into another product such as a gum, food product, etc. In several embodiments it is contemplated that a capsule may be used in conjunction with other food products such as gums, liquids, larger tablets, caplets, etc.

In various embodiments, the capsule is capable of disintegrating or breaking apart in an oral cavity from about 1 second to about 60 seconds or from about 1 second to about 45 seconds or from about 1 second to about 30 seconds or from about 1 second to about 15 seconds or in less than about 20 seconds or less than about 10 seconds. The capsules of the present invention leave little or minimal to no gelatin residue in the oral cavity.

A capsule may have a diameter from about 0.1 mm to about 10 mm. The at least one hygroscopic polyol may be present in an amount from about 1% to about 50% by weight or from about 10% to about 30% by weight. The at least one polyol with a low hygroscopicity may be present in an amount from about 1% to about 50% by weight or from about 10% to about 50% by weight. The film or gel forming agent may be present in an amount from about 40% to about 95% by weight or from about 50% to about 80% by weight.

An embodiment of the present invention provides for a fast disintegrating capsule with a single inner hydrophobic core layer and a single hydrophilic outer layer, wherein the capsule is stable and does not experience any cracking or breaking in the outer layer. This type of capsule may be advantageous for several reasons. Depending on the materials utilized in the capsule, a capsule having multiple hydrophilic or water soluble outer layers may affect the desired disintegration performance of the capsule. For instance, a capsule with a hydrophobic core layer and two or more outer water soluble layers may not disintegrate as quickly as a capsule that has a single core layer and a single outer water soluble layer. Additionally, having a single core hydrophobic layer and a single outer water soluble layer may be advantageous from a manufacturing efficiency point of view.

Another embodiment of the present invention provides for a seamless microcapsule with three layers, namely, the core layer, a middle layer and an outer shell layer. The middle layer may be added to the microcapsule by a third injection nozzle. The middle layer may provide for a more stable microcapsule. More particularly, the middle layer may provide for additional protection for the shell layer and prevent or minimize migration of the core layer to the outer shell layer.

In several embodiments of the present invention, one useful capsule is a seamless capsule. Such seamless capsules typically include at least one inner layer, defined as the ‘core layer’ and at least one outer layer, defined as a shell layer. Multiple layers may surround the inner core layer. One such layer that may be located between a core layer and an outer layer may be referred to as a protective or outer coating layer.

An embodiment of the present invention is shown in FIG. 1, wherein a multilayered capsule includes an inner core layer and an outer shell layer. Other embodiments of the present invention include capsules with more layers such as an additional layer between the core and shell layer and/or an additional layer on the outside of the outer shell layer. Several embodiments of the present invention provide for a capsule that has 2, 3, 4, 5 phases or layers. The thickness of each layer may be adjusted by varying the ratio of the various solutions. Suitable enteric agents include pectin, alginic acid, cellulose such as carboxyl methylcellulose, cellulose acetate phthalate, and the like, Eudragit® which is one of an acrylic copolymer and the like and combinations thereof.

Useful film or gel forming agents for the at least one outer layer include but are not limited to gelatins, proteins, polysaccharides, starches, celluloses and combinations thereof. Useful film or gel forming agents, such as those suitable for the at least one outer layer include, but are not limited to, gelatin, pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, tragacanth gum, guar gum, acacia gum, arabic gum, polyacrylic acid, methylmethacrylate copolymers, carboxyvinyl polymers, amylose, high amylose starch, hydroxypropylated high amylose starch, dextrin, chitin, chitosan, levan, elsinan, collagen, zein, gluten, soy protein isolate, whey protein isolate, casein and combinations thereof.

Useful agents for hydrophilic, water soluble outer coatings or shell layers include but are not limited to, gelatin, albumin, pectin, guar gum, carboxymethyl starches, carboxymethyl celluloses, carrageenan, agar and the like, hydroxypropylcellulose, ethycellulose, hydroxypropylmethyl cellulose, such as Aquacoat®, polyvinyl alcohol, polyvinyl pyrrolidone, pullulan and combinations thereof. When the material for forming the coating layer contains protein or polysaccharide, useful amounts include an amount from about 100 parts by weight to about one part by weight. Other useful materials in the outer, coating or shell layer include an enteric material, a plasticizer, a preservative and a colorant and the like and combinations thereof.

To adjust the hardness of the shell, a material that increases the hardness of the shell material after hardening, such as sorbitol, can be added to the shell material along with the plasticizer. Furthermore, by adding a thickening polysaccharide, a gelling agent, a proteolytic agent or the like, it is possible to improve the long-term stability of the shell.

The shell material can be colored to any arbitrary color tone by a pigment, and flavorings, sweeteners, souring agents or the like can be added. Sorbitol, thickening polysaccharides, gelling agents, proteolytic agents and the like are added at 10% by mass or less with respect to the total amount of the shell material, and preferably at 5% by mass or less.

Useful materials in a water soluble phase include plasticizers, which include polyhydric alcohols, such as sorbitol, glycerin, polyethylene glycol and the like and combinations thereof. A water-soluble polyvalent alcohol or water-soluble derivative thereof may also be used in water soluble outer or coating layer. Useful examples of polyvalent alcohol or water soluble derivatives thereof include but are not limited to, glycerin, polyglycerin, sorbitol, ethylene glycol, polyethylene glycol, propylene glycol, polypropylene glycol, ethylene oxide-propylene oxide copolymer, oligosaccharide, sugar ester, glyceride, sorbitan ester and the like. Useful preservatives and colorants include benzoic acid, para-oxybenzoate, caramel colorant, gardenia colorant, carotene colorant, tar colorant and the like and combinations thereof.

A film substance may be used on the water soluble outer or shell layer and may be formed by treating a capsule with a film forming substance. Suitable film formers include but are not limited to albumin, pectin, guar gum, carrageenan, agar and the like, hydroxypropylcellulose, ethycellulose, hydroxypropylmethyl cellulose, such as Aquacoat®, pullulan and combinations thereof.

Useful amounts of additives include 2 parts by weight to 98 parts by weight, based on 100 parts by weight of gelatin in the coating layer. In order to inhibit oxygen-permeability of the capsule of the present invention, sucrose may be contained in the coating layer, in addition to the film-forming material and additives. When sucrose is not contained in the coating layer, oxygen may permeate through the water-soluble gel layer to reach the content and oxidize the unsaturated fatty acid and derivative thereof during a long storage period of time. Oxidized unsaturated fatty acid and derivative thereof increase peroxide value (POV) and deteriorate product quality. Sucrose efficiently inhibits the disadvantage. Sucrose may be contained in an amount of one part by weight to 100 parts by weight based on 100 parts by weight of gelatin.

A water-soluble layer or phase may also contain an acid or an acid salt thereof, to minimize or prevent the capsule from insolubilizing. Useful acids or acid salt thereof include a water-soluble organic acid, an inorganic acid, or an acid salt thereof (for example, sodium salt). Suitable organic acid include acids having 2 to 6 carbon atoms, including, for example, citric acid, malic acid, tartar acid, fumaric acid, lactic acid, butyric acid, succinic acid and the like, an acid salt thereof (for example, sodium malate, potassium succinate, calcium citrate and the like); and combinations thereof. Useful inorganic acids include phosphoric acid, polyphosphoric acid, carbonic acid, an acid salt thereof (for example, dibasic sodium phosphate) and combinations thereof. Useful amounts of an acid or acid salt thereof to a water-soluble layer is generally from about 0.01 to about 50% by weight, or from about 0. 05 to about 20% by weight, based on 100% by weight of a water soluble layer or phase.

The inner or core solution or phase of a capsule may include a fatty acid such as a unsaturated fatty acid or a derivative thereof. Suitable materials for the inner core include but are not limited to, vegetable fats and oils, animal fats and oils and mineral oils and combinations thereof. Suitable materials for the inner core include fish oils and a purified material thereof, liver oils, eicosapentaenoic acid (EPA), docosahexaenoic acid (DHA), arachidonic acid, prostaglandin and a derivative thereof, sucrose fatty acid ester, propylene glycol fatty acid ester, glycerin fatty acid ester, long chain fatty acid triglyceride, medium chain fatty acid triglyceride, ampho-ionic emulsifiers, lecithin, sesame oil, coffee oil, rapeseed oil, brown rice oil, liquid paraffin and combinations thereof.

To prepare an emulsified core liquid, well-known conventional methods can be used in which the main component, including an emulsifying agent, and an oil component are emulsified using a homogenizer to obtain an oil-in-water emulsion. Other useful materials for the core or inner phase include, but are not limited to, various types of a stabilizers for unsaturated fatty acid or a derivative thereof including antioxidants, such as vitamin E, vitamin C, β-carotene, eucalyptol, menthol, flavorings, sweeteners, wheat germ oil and the like and combinations thereof.

The core filler material can be in a liquid state when extruded from the multiple nozzle as the core liquid, and the core liquid can remain a liquid after the formation of the multilayer liquid drops, or alternatively can be a gel or solid after formation of the seamless capsule. The core material may include a foodstuff, health food, flavoring, condiments, pharmaceutical, aromatic agent, or the like, it is possible to include various additives such as solvents (for example, edible oils), sweeteners, souring agents, flavorings, colorings, thickeners (gelatinizing agents), stabilizers, and emulsifiers, or the like that are permitted in terms of food production or pharmacology. When the core material is prepared in a liquid state, it can take the form of a transparent solution, suspension, or a latex (cream) where the main component is dissolved in a solvent. The method in which a core liquid filler material is prepared can be any well-known method in the fields of food production or pharmaceutical manufacturing. For example, to prepare a transparent core liquid, the main component and additives are measured and mixed with a solvent such as a edible oil, and as needed heated and agitated to produce a uniform solution.

Useful amounts of the inner or core phase is from about 10% to 95% by weight, or from about 40% to about 90% by weight, based on the total weight of the capsule.

In several embodiments of the present invention, the seamless capsule may contain a viscous liquid which is scarcely miscible with water between an outer film and the inner or core phase. The viscous liquid which is scarcely miscible with water may be liquid having a viscosity of not more than 1000 cp at 100 C. Examples thereof include emulsifiers, oils, resins and the like and they may be used alone or in combination thereof. Examples of the emulsifier include nonionic emulsifiers having HLB value of 2 to 8 such as sucrose fatty acid ester, propylene glycol fatty acid ester, glycerin fatty acid ester (e.g. long chain fatty acid triglyceride, medium chain fatty acid triglyceride, such as NeoBee®, etc.), ampho-ionic emulsifiers such as lecithin or a mixture thereof. Examples of oils include vegetable fats and oils, animal fats and oils and mineral oil of which solubility in 100 g of absolute alcohol at 150 C is not more than 50 g, for example, sesame oil, coffee oil, rapeseed oil, brown rice oil, liquid paraffin and combinations thereof. Further, dl-alpha-tocopherol, isobutylene polymers (e.g. polybutylene, polybutene, etc.), resins (e.g. silicone resin, vinyl acetate resin, etc.), silicon dioxide, such as Cab-o-sil® and the like can be used. The viscous liquid may be present between the content and film in the case of producing the capsule. However, it is not necessarily required that the viscous liquid is present between the content and film, and it may be present in the content in the separate state.

The inner or outer layer may include other materials including APIs, foods, cosmetics, flavors, industrial chemicals and the like.

In various embodiment of the present invention, there is provided a capsule having an encapsulated or partially encapsulated hydrophilic compound(s) in a hydrophobic carrier in an inner layer. Such capsules do not experience cracks or breaks in surrounding outer layer(s) that may have a hydrophilic carrier or phase.

Encapsulation of drugs is known to be useful for providing sustained release versions of certain APIs. While it may be desirable in certain circumstances to provide for a sustained release product so that API is released into the patient over an extended period of time, it would not be desirable to encapsulate a drug if an immediate release product is desired. Various embodiments of the present invention there are provided capsules, such as seamless capsules, are designed to disintegrate in the buccal cavity. Stable capsules can be provided by encapsulating or partially encapsulating the API contained therein.

Partially encapsulating APIs, including hydrophilic APIs, is advantageous since it minimizes or eliminates the outer shell cracking issue while not creating an undesirable sustained release API. Another embodiment of the present invention also provides for a seamless capsule containing an encapsulated API wherein the encapsulated API is available for immediate release in the patient. In such embodiments, the encapsulation is in an effective amount to minimize or eliminate migration of the API to the outer shell. Alternatively, the encapsulation is in an effective amount to minimize or eliminate the deformations in the outer shell such as cracks, breaks and the like and combinations thereof. An API may be partially encapsulated, fully encapsulated, partial adsorbates, full adsorbates or combinations thereof.

Several embodiments of the invention contemplate that APIs can be encapsulated, partially encapsulated, adsorbed as a complex or partially adsorbed as a complex. Encapsulation can be achieved using conventional procedures and can be performed using water-insoluble as well as water-soluble agents. Alternatively, it is possible to encapsulate a release controlling substance, together with an API, within an encapsulating shell to provide for controlled release of a taste-masked capsule.

For instance, an API may be encapsulated or partially encapsulated by first granulating the API with a sufficient quantity of the desired encapsulation material. The wet mass is passed through a mesh screen such as a 10 mesh screen to break up any lumps, if necessary. The granules are dried over a forced air oven at 50° C. The dried powder is passed through a screen, such as a 40 mesh screen. The powder is then ready to be incorporated into the core inner solution.

Suitable materials that can be used to encapsulate or partially encapsulate an API include, but are not limited to, hydroxypropylcellulose, ethycellulose, hydroxypropylmethylcellulose(Aquacoat®), ethylcellulose, methacrylates, acrylic co-polymers such as Eudragit® (Butylmethacrylat-(2-Dimethylaminoethyl)methacrylat-Methylmethacrylat-Copolymer (1:2:1)″), KOLLICOAT®, polyvinylpyrrolidone and combinations thereof. The pharmaceutical composition can include other functional components presented for the purpose of modifying the physical, chemical or taste properties of the systemically active therapeutic agent. For example, the API can be in the form of a microencapsulation, ion-exchange resin complex, such as a sulfonated polymers, electro-chemical melt, supercritical fluids, magnesium trisilicate, coacervation, or cyclodextrin (cyclic-linked oligosaccharides) complexes. Useful sulphonated polymers include polystyrene cross-linked with 8% of divinylbenzene such as Amberlite® IRP-69 and IRP-64 (obtained by Rohm and Haas), Dow XYS-40010.00®, Dow XYS40013.00® (obtained from the Dow Chemical Company).

An aspect of the present invention provides for a seamless capsule or capsule that includes an encapsulated or partially encapsulated API in a therapeutically effective amount. Useful APIs include antimicrobial agents, non-steroidal anti-inflammatory agents, antitussives, decongestants, anti-histamines, expectorants, anti-diaherrals, H₂-antagonists, proton pump inhibitors, analgesics, stimulants and combinations thereof. Useful APIs include diphenhydramine, dextromethorphan, phenylephrine, menthol, pseudoephedrine, acetaminophen, ibuprofen, famotidine, guaifenesin, ketoprofen, nicotine, celecoxib, valdecoxib, chlorpheniramine, fexofenadine, loratadine, desloratadine, cetirizine, ranitidine, simethicone, and isomers, pharmaceutically acceptable salts and prodrugs thereof and combinations thereof.

Useful amounts of phenylephrine include from about 1 milligram to about 60 mg, from about 1 mg to about 15 mg or from about 5 mg to about 10 mg or about 10 mg.

Various embodiments of the present invention provide compositions with at least two API's.

Useful API's include, but are not limited to:

(a) antimicrobial agents such as triclosan, cetylpyridium chloride, domiphen bromide, quaternary ammonium salts, zinc compounds, sanguinarine, fluorides, alexidine, octonidine, EDTA, and the like;

(b) non-steroidal anti-inflammatory and pain reducing agents such as aspirin, acetaminophen, ibuprofen, ketoprofen, diflunisal, fenoprofen calcium, flurbiprofen sodium, naproxen, tolmetin sodium, indomethacin, celecoxib, valdecoxib, parecoxib, rofecoxib and the like;

(c) antitussives such as benzonatate, caramiphen edisylate, menthol, dextromethorphan hydrobromide, chlophedianol hydrochloride and the like;

(d) antihistamines such as brompheniramine maleate, chlorpheniramine maleate, carbinoxamine maleate, clemastine fumarate, dexchlorpheniramine maleate, diphenylhydramine hydrochloride, azatadine maleate, diphenhydramine citrate, diphenhydramine hydrochloride, diphenylpyraline hydrochloride, doxylamine succinate, promethazine hydrochloride, pyrilamine maleate, tripelennamine citrate, triprolidine hydrochloride, acrivastine, loratadine, desloratadine, brompheniramine, dexbropheniramine, fexofenadine, cetirizine, montelukast sodium and the like;

(e) expectorants such as guaifenesin, ipecac, potassium iodide, terpin hydrate and the like;

(f) analgesic-antipyretics such salicylates, phenylbutazone, indomethacin, phenacetin and the like;

(g) antimigraine drugs such as sumitriptan succinate, zolmitriptan, valproic acid eletriptan hydrobromide and the like;

(h) anti-gas and anti-diaherrals such as simethicone, loperimide,

(i) H₂-antagonists, proton pump inhibitors such as ranitidine, famotidine, omeprazole and the like; and

(j) central nervous system agents,

The amount of the API's in the formulation may be adjusted to deliver a predetermined dose of the active agent over a predetermined period of time, which may typically vary from 4 to 24 hours. Examples of doses containing specific pharmaceutically active agents are set forth in Table 1.

TABLE 1

| Pharmaceutically Active Agent | Dose | |
|---|---|---|
| Chlorpheniramine Maleate | 4-12 | mg |
| Brompheniramine Maleate | 4 | mg |
| Dexchlorpheniramine | 2 | mg |
| Dexbropheniramine | 2 | mg |
| Triprolidine Hydrochloride | 2.5 | mg |
| Cetirizine | 5-10 | mg |
| Acrivastine | 8 | mg |
| Azatadine Maleate | 1 | mg |
| Loratadine | 5-10 | mg |
| Dextromethorphan Hydrobromide | 10-30 | mg |
| Ketoprofen | 12.5-25 | mg |
| Sumatriptan Succinate | 35-70 | mg |
| Zolmitriptan | 2.5 | mg |
| Nicotine | 1-15 | mg |
| Diphenhydramine Hydrochloride | 12.5-25 | mg |
| Atorvastatin | 5-80 | mg |
| Valdecoxib | 5-20 | mg |
| Celecoxib | 5-20 | mg |
| Rofecoxib | 5-25 | mg |
| Ziprasidone | 20-80 | mg |
| Eletriptan | 10-40 | mg |

Except as otherwise noted, the amount of API is designated as % by weight per dosage form. Generally, the amount of the API used may be from about 0.01% to about 80% by weight, or from about 0.1% to about 40% by weight, or from about 1% to about 30% by weight, or from about 1% to about 10% by weight.

An “effective” amount or a “therapeutically effective amount” of an active ingredient refers to a non-toxic but sufficient amount of the agent to provide the desired effect. The amount of active agent that is “effective” will vary from subject to subject, depending on the age and general condition of the individual, the particular active agent or agents, and the like. Thus, it is not always possible to specify an exact “effective amount.” However, an appropriate “effective” amount in any individual case can be determined by one of ordinary skill in the art using routine experimentation.

“Pharmacologically active” (or simply “active”), refers to a compound that has pharmacological activity and a “pharmacologically active” derivative of an active agent, refers to a derivative having the same type of pharmacological activity as the parent compound and approximately equal in degree. When the term “pharmaceutically acceptable” is used to refer to a derivative (e.g., a salt) of an active agent, it is to be understood that the compound is pharmacologically active as well. When the term “pharmaceutically acceptable” is used to refer to an excipient, it implies that the excipient has met the required standards of toxicological and manufacturing testing or that it is on the Inactive Ingredient Guide prepared by the Food and Drug Administration.

By “pharmaceutically acceptable” such as in the recitation of a “pharmaceutically acceptable excipient,” or a “pharmaceutically acceptable additive,” is meant a material that is not biologically or otherwise undesirable, i.e., the material can be incorporated into a pharmaceutical composition administered to a patient without causing any undesirable biological effects or interacting in a deleterious manner with any of the other components of the composition in which it is contained.

In various embodiments of the present invention, the dosage forms may be administered orally. Oral administration may involve swallowing, so that the composition with the API(s) enters the gastrointestinal tract, and/or buccal, lingual, or sublingual administration by which the API enters the blood stream directly from the mouth.

Useful inactive ingredients that may be included in the various phases or solutions of the capsule, may include but are not limited to, binding agents, filling agents, lubricating agents, suspending agents, sweeteners, flavorings and flavor enhancer agents, taste-masking agents, preservatives, buffers, wetting agents, anti-oxidants, colorants or coloring agents, pharmaceutically acceptable carriers, disintegrants, salivary stimulating agents, cooling agents, co-solvents (including oils), pH adjusting agents, effervescent agents, emollients, bulking agents, anti-foaming agents, surfactants, soluble organic salts, permeabilizing agents, glidants and other excipients and combinations thereof. Desirably, the agents are chemically and physically compatible with the API.

Examples of useful substantially water soluble carriers or filling agents include, but are not limited to, various starches, celluloses, carbohydrates compression sugars or soluble fillers. More particularly, useful fillers include but are not limited to lactose, lactose monohydrate, lactose anhydrous, sucrose, amylose, dextrose, mannitol, inositol, maltose, maltitol, sorbitol, glucose, xylitol, erythritol, fructose, maltodextrins; microcrystalline cellulose, calcium carboxy methyl cellulose; pregelatinized starch, modified starches, potato starch, maize starch; clays, including kaolin and polyethylene glycols (PEG) including PEG 4000; or combinations thereof. Useful amount of fillers include the range of about 1 to about 99 weight percent, or about 25 to about 95 weight percent or about 40 weight percent to about 95 weight percent of the compositions of this invention.

Compositions of the present invention may include a sweetener. Useful sweeteners include, but are not limited to, sugars such as sucrose, glucose (corn syrup), dextrose, invert sugar, fructose, and mixtures thereof, acid saccharin and its various salts such as the sodium or calcium salt; cyclamic acid and its various salts such as the sodium salt; the dipeptide sweeteners such as aspartame and alitame; natural sweeteners such as dihydrochalcone compounds; glycyrrhizin; Stevia rebaudiana (Stevioside); sugar alcohols such as sorbitol, sorbitol syrup, mannitol, xylitol and the like, synthetic sweeteners such as acesulfame-K and sodium and calcium salts thereof and other synthetic sweeteners, hydrogenated starch hydrolysate (lycasin); protein based sweetening agents such as talin (thaumaoccous danielli) and/or any other pharmacologically acceptable sweetener known by the state of the art, and mixtures thereof.

Suitable sugar alcohols useful as sweeteners include, but are not limited to, sorbitol, xylitol, mannitol, galactitol, maltitol, isomalt (PALATINIT™) and mixtures thereof. The exact amount of sugar alcohol employed is a matter of preference subject to such factors as the degree of cooling effect desired. Thus, the amount of sugar alcohol may be varied in order to obtain the result desired in the final product and such variations are within the capabilities of those skilled in the art without the need for undue experimentation.

In another embodiment, a capsule is free of sugar. A sugar-free formulation has the advantage that it can be administered easily to consumers with blood sugar disorders or to diabetics in need of such preparations. Such sweeteners include, but are not limited to, sucralose, acesulfame potassium, and aspartame which share properties such as absence of bitter and metallic aftertastes.

In another embodiment, a capsule may include acesulfame K, aspartame, sucralose and combinations thereof. Acesulfame K is a commercial product of Nutrinova Nutrition Specialties & Food Ingredient GmbH. Useful amounts of sucralose in a dosage form is between about 0.002% to about 10% by total weight of the FDDF. However, this amount can vary greatly depending upon the nature of the composition being sweetened. In one preferred embodiment, the sweetener is a mixture of sucralose with acesulfame K.

One embodiment of the invention provides for a controlled or extended release composition.

Optionally, one or more flavors such as those described in U.S. Pat. No. 6,596,298 which is incorporated herein. Any amount of flavor can be used and will depend on characteristics of the active pharmaceutical ingredient(s); preferred concentration of flavoring is between about 0.01% to about 10% w/w of a composition.

Another embodiment of the present invention provides a kit having two or more separate compositions having an API in capsules, including seamless capsules, and a means for separately retaining said capsules, such as a container, divided bottle, or divided foil packet. An example of such a kit is the familiar blister pack used for the packaging of capsules and the like. Other embodiments contemplate articles of manufacture including various packaging configurations, ranging from unit dose blister packs to multiple dose packages such as bottles. To assist compliance, the kit may have directions for administration and may be provided with a so-called memory aid.

In one embodiment, capsules are provided in blister packaging which is believed to limit the amount of oxygen that may interact with the capsule and as such may also increase or enhance the stability of the drug product containing the API. Another embodiment contemplates a method of dispensing a capsule from a blister pack by forcing the drug product through a foil back on a blister pack.

An embodiment of the present invention provides a method for producing the encapsulated unsaturated fatty acid substance may be a conventional method for producing a soft capsule. An example of the method for producing the capsule includes a method containing steps of preparing a sheet for the coating layer mainly containing gelatin and a sheet for the water-soluble gel layer containing an acid or an acid salt thereof, respectively, laminating both sheets, drying to obtain a dried sheet and encapsulating unsaturated fatty acid or the derivative thereof as the content with the dried sheet on a rotary filler to form a seamed capsule; and another method for producing a seamless capsule by using an instrument equipped with some nozzles arranged concentrically.

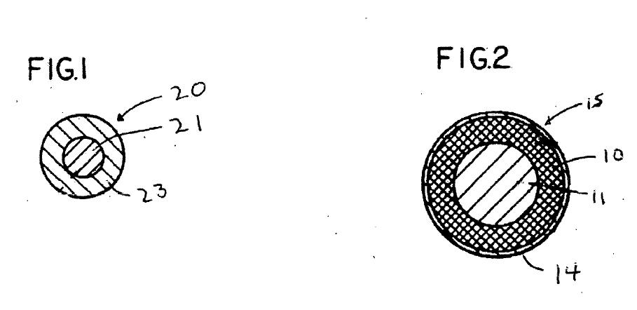

Seamless microcapsules may be manufactured by any acceptable machinery such as the seamless minicapsule production machine, such as the Spherex, manufactured by Freund Corp., Japan as shown in FIG. 2. Highly spherical uniform, seamless capsules may be produced by such machinery. A useful manufacturing process for seamless capsules, including seamless microcapsules, includes mixing the components of the core in one container and the components of the shell(s) in another container. The shell(s) materials are heated to provide a fluid medium. The core and shell(s) materials are then pumped separately to at least two fluid nozzles submerged in an organic carrier medium. The capsules formed are allowed to cooled and stiffen. They are then denatured and separated for further handling. Additional solutions may be injected to form a three or more system microcapsule. The core solution and the shell solution must be different. The principle of seamless minicapsule formulation is the utilization of surface tension. In particular, when two different solutions contact each other, surface tension works to reduce the contact area of the solution resulting in a spherical shape.

Suitable methods for producing seamless capsules are disclosed in U.S. Pat. No. 5,330,835 and U.S. Pat. No. 6,531,150, US2004/0051 192, U.S. Pat. No. 5,478,508 which are incorporated herein in their entirety.

FIG. 1 schematically shows a cross-sectional view of a capsule (20), with an inner core material (21) with a coating layer (23). FIG. 2 schematically shows a cross-sectional view of a capsule (15), with an inner core material (11), a coating layer (10) and a film layer (14).

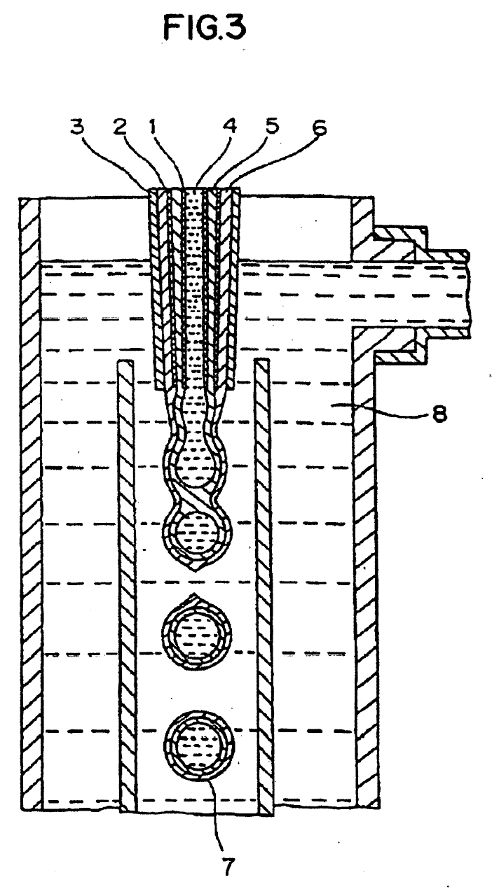

FIG. 3 is a schematic cross section illustrating one embodiment of the present invention which is suitable for producing a seamless capsule. The inner core material (4) of the capsule supplied to the nozzles is extruded from an annular end of an inner nozzle (called the first nozzle) (1), the material for forming the water-soluble gel layer (5) is extruded from an annular end of an intermediate nozzle (called the second nozzle) (2) and optionally a film-forming material for a coating layer (6) is extruded from an annular end of an outer nozzle (called the third nozzle) (3), simultaneously, to make a three-phase composite jet stream, followed by releasing the jet stream into a cooling solution (8) to obtain the encapsulated unsaturated fatty acid substance (7) of the present invention in a form of the seamless capsule.

In the method of the present invention, since all of the loading materials are liquid, the encapsulation process can be easily performed by adequately vibrating the jet stream with a vibration means to readily release the jet stream, and thereby a particle size of the resulting capsules may be controlled uniformly.

The encapsulated unsaturated fatty acid substance (7) produced by the method of the present invention may be used in any way of an undried form remaining moisture in the coating layer, or a dried form.

The capsule of the present invention may be formed into a desirable particle size of 0.1 mm to 20 mm, preferably 0.3 to 8 mm. The water-soluble outer layer (12) may have a thickness from about 0.001 to about 5.00 mm, or from about 0.01 to 1 mm.

### EXAMPLES

TABLE 2

| | Capsule 1 | Capsule 2 | Capsule 3 | Capsule 4 |
|---|---|---|---|---|
| | % Target | % Target | % Target | % Target |
| Outer Layer | | | | |
| Gelatin | 58.5% | 58.5% | 58.5% | 58.5% |
| Glycerin | 20.0% | 20.0% | 20.0% | 20.0% |
| Isomalt | 20.0% | 20.0% | 20.0% | 20.0% |
| Sucralose | 1.5% | 1.5% | 1.5% | 1.5% |
| Purified Water | — | — | — | — |
| Weight of | 6 mg | 6 mg | 6 mg | 6 mg |
| Outer Shell | | | | |
| Middle Layer | | | | |
| Hydrogenated | 95.00% | | 95.00% | |
| Vegetable Oil | | | | |
| Soybean Lecithin | 5.00% | | 5.00% | |
| Weight of | 82.67 mg | | 82.67 mg | |
| Middle Layer | | | | |
| Core Layer | | | | |
| Hydrogenated | 80.84% | 80.84% | 80.84% | 78.16% |
| Vegetable Oil | | | | |
| Sucralose NF | 1.88% | 1.88% | 1.88% | 1.88% |
| Acesulfame | 1.25% | 1.25% | 1.25% | 1.25% |
| potassium salt | | | | |
| Menthol | 7.50% | 7.50% | 7.50% | 7.50% |
| Eucalyptol | .31% | .31% | .31% | .31% |
| phenylephrine | 6.25% | | | |
| HCl | | | | |
| Phenylephrine | | | | 8.93% |
| HCl (see Table | | | | |
| 3) | | | | |
| Cetirizine HCl | | | 6.25% | |
| Famotidine | | 6.25% | | |
| Orange Flavoring | 1.3125% | 1.3125% | 1.3125% | 1.3125% |
| Silicon Dioxide, | 0.6562% | 0.6562% | 0.6562% | 0.6562% |
| Colloidal | | | | |
| Anhydrous | | | | |
| Weight of Core | 160 mg | 160 mg | 160 mg | 160 mg |
| Solution | | | | |
| Total Weight | 248.67 mg | 166 mg | 248.67 mg | 166 mg |
| of Capsule | | | | |

The formulations in Table 2 are mixed to prepare the respective layers of a capsule. The hydrophilic outer layer liquid is prepared by adding purified water in a suitable size container with glycerin, isomalt, sucralose while mixing at 30 C±5 C until the ingredients completely dissolve. Gelatin is then added and the mixture is heated to 60 C±5 C while mixing for about 1 to 2 hours to dissolve all ingredients. Mixing is stopped and the temperature kept at 60 C±5 C for one to two hours to remove air bubbles. The solution is transferred to an encapsulation tank while maintaining the temperature at 60 C±5 C. The protective layer is prepared by melting hydrogenated vegetable oil such as Melba 26 in an oven at 50 C±5 C and mixing with lecithin while maintaining the temperature for 2-5 hours to allow the Lecithin to dissolve. The mixture is maintained for about 30 minutes at 40 C±5 C without stirring to remove air bubbles. The core liquid phase is prepared by melting hydrogenated vegetable oil such as Melba26 in an oven at a temperature from about 40 C to about 55 C and mixing in menthol until it dissolves. Eucalyptol and orange flavor are added while continuing to mix at a temperature from about 30 to about 45 C for about 1 hour. Phenylephrine and silicon dioxide, sucralose and Acesulfame potassium salt are added while maintaining the temperature and mixing. The mixture is homogenized for about 20 minutes while mixing with a stirring speed from about 2500 to about 8500 rpm while maintaining the temperature from about 30 C to about 45 C.

To form capsule, the materials are extruded through a triple nozzle arranged concentrically and released into a cooling solution (vegetable oil) to produce capsules in form of a triple structure.

TABLE 3
Coating/Encapsulating Materials

Ethylcellulose
Acrylic copolymer
Hydroxypropyl cellulose

Phenylephrine is partially encapsulated by granulating phenylephrine with the encapsulating materials listed in Table 3. The wet granulation mass is passed through a 10 mesh screen. The granules are dried over a forced air oven at 50° C. The dried powder is passed through a 40 mesh screen and the powder is then mixed into the core solution.

While the invention has been described in detail and with reference to specific examples thereof, it will be apparent to one skilled in the art that various changes and modifications can be made therein without departing from the spirit and scope thereof of the invention.

What is claimed is:

1. A capsule comprising a hydrophobic inner core and at least one hydrophilic outer layer; said outer layer comprises at least one hygroscopic polyol and at least one polyol with a low hygroscopicity.

2. The capsule according to claim 1, wherein said at least one hydrophilic outer layer further comprises at least one film or gel forming agent.

3. The capsule of claim 1, said polyol with a low hygroscopicity comprises isomalt.

4. The capsule of claim 1, said hygroscopic polyol is selected from the group consisting of glycerin, sorbitol, mannitol, xylitol, maltitol, lactitol, erythritol and the like and combinations thereof.

5. The capsule according to claim 2, wherein said at least one film or gel forming agent is selected from the group consisting of gelatin, pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, tragacanth gum, guar gum, acacia gum, arabic gum, polyacrylic acid, methylmethacrylate copolymers, carboxyvinyl polymers, amylose, high amylose starch, hydroxypropylated high amylose starch, dextrin, chitin, chitosan, levan, elsinan, collagen, zein, gluten, soy protein isolate, whey protein isolate, casein and combinations thereof.

6. The capsule of claim 1, said hydrophobic inner core comprises at least one active pharmaceutical ingredient in a pharmaceutically effective amount.

7. The capsule of claim 1, wherein said capsule further comprises at least one additional layer located between the inner core and the hydrophilic outer layer.

8. The capsule of claim 1, wherein said capsule is a standalone product that is capable of disintegrating completely in an oral cavity of a consumer.

9. The capsule of claim 8, wherein said capsule disintegrates in an oral cavity in less than about 20 seconds and does not leave a gelatin residue in the oral cavity.

10. The capsule of claim 1, wherein said capsule has a seamless outer layer.

11. The capsule of claim 1, wherein said capsule is stable and said at least one outer layer experiences minimal degradation at accelerated stability conditions at 30° C./65% relative humidity.

12. The capsule according to claim 1, wherein said capsule has a diameter from about 0.1 mm to about 10 mm.

13. The capsule according to claim 1 wherein said at least one hygroscopic polyol is present in an amount from about 1% to about 50% by weight.

14. The capsule according to claim 1 wherein said at least one hygroscopic polyol is present in an amount from about 10% to about 30% by weight.

15. The capsule according to claim 1 wherein said at least one polyol with a low hygroscopicity is present in an amount from about 1% to about 50% by weight.

16. The capsule according to claim 1 wherein said at least one polyol with a low hygroscopicity is present in an amount from about 10% to about 40% by weight.

17. The capsule according to claim 6, wherein said active pharmaceutical ingredient is encapsulated or partially encapsulated with an acrylic copolymer.

18. The capsule according to claim 6, wherein said active pharmaceutical ingredient is selected from the group consisting of diphenhydramine, dextromethorphan, menthol, phenylephrine, pseudoephedrine, acetaminophen, ibuprofen, famotidine, guaifenesin, ketoprofen, nicotine, celecoxib, valdecoxib, chlorpheniramine, fexofenadine, loratadine, desloratadine, cetirizine, ranitidine, simethicone, and isomers, pharmaceutically acceptable salts and prodrugs thereof and combinations thereof.

19. A capsule comprising a hydrophobic inner core and at least one hydrophilic outer layer; said outer layer comprises at least one film or gel forming agent, at least one hygroscopic polyol and at least one polyol with a low hygroscopicity; said hydrophobic inner core comprises at least one active pharmaceutical ingredient in a pharmaceutically effective amount and said at least one outer layer experiences minimal degradation at 30° C./65% relative humidity.

20. A package comprising a capsule comprising a hydrophobic inner core and at least one hydrophilic outer layer; said outer layer comprises at least one hygroscopic polyol and at least one polyol with a low hygroscopicity; said package comprises drug facts attached thereto.
